(19) United States
(12) Patent Application Publication
(10) Pub. No.: US 2024/0417495 A1
(43) Pub. Date: Dec. 19, 2024

(54) POLYVINYL ACETALS WITH IMPROVED RESIDUAL PARTICLE SIZE DISTRIBUTION

(71) Applicant: Kuraray Europe GmbH, Hattersheim am Main (DE)

(72) Inventors: Florian MUMMY, Frankfurt am Main (DE); Christian JANSSEN, Hattersheim am Main (DE)

(73) Assignee: Kuraray Europe GmbH, Hattersheim am Main (DE)

(21) Appl. No.: 18/701,327

(22) PCT Filed: Nov. 17, 2022
(86) PCT No.: PCT/EP2022/082316

§ 371 Date: Apr. 15, 2024

(30) Foreign Application Priority Data
Nov. 18, 2021 (EP) 21208989.0

(51) Int. Cl. C08F 16/34; C08J 3/14

(52) U.S. Cl. CPC C08F 16/34; C08J 3/14; C08J 2329/14

(57) ABSTRACT

The invention is directed to the polyvinyl acetals with an improved residual particle size, methods for the production of such polyvinyl acetals and their use as binder for the production of ceramic green sheets.

The invention is directed to polyvinyl acetals with an improved residual particle size distribution, methods for the production of such polyvinyl acetals and their use as binder for the production of ceramic green sheets.

Ceramic materials like ceramic capacitators for the electronics industry are generally produced by sintering of a so-called green sheet, i.e. a film-like, thin moulded body, which contains the ceramic materials. For the production of these green sheets, a suspension of metal oxides, plasticizers, dispersing agents and binders in organic solvents is produced. This suspension is subsequently applied by means of a suitable process (i.e. doctor blade process) in the desired thickness onto a carrier film and the solvent is removed. The green sheet thus obtained must be free from cracks, exhibit a smooth surface and still have a certain elasticity.

Polyvinyl acetals such as polyvinyl butyral (PVB) are frequently used as binders for the production of ceramic green sheets. To this end, DE 4 003 198 A1 describes the production of a casting slip for ceramic green films in which PVB with a residual polyvinyl acetate content of 0 to 2% by weight is used as binder.

In recent years, multi-layer ceramic capacitors (MLCC) are becoming increasingly important for the electronic industry. MLCCs consist of a number of individual capacitors stacked together in parallel and contacted via the terminal surfaces. Due to the advancing miniaturization of the electronic components, the size of the powder particles, e.g. the metal oxide particles, can be in the nanometre range. Residual particles, i.e. particles that do not dissolve in the solvent (mixture) used to make the suspension required to produce the green sheets, of the same size as the metal oxide particles, are of major concern as they are difficult to be selectively removed and thus, can lead to defects in the ceramic layers after sintering of the green sheets.

Moreover, residual particles in the low nanometre range pose the additional problem that they tend to clog up the screens used to filter the binder solutions and thus, make the process less economic since the screens need to be replaced or cleaned more often. Additionally, even partial clogging of the screens leads to high back pressures during the filtration process. In addition, polymeric particles are in general difficult to filtrate, due to the soft behaviour of the swollen polymer particles in solution.

Thus, one objective of the invention was to provide polyvinyl acetals used as binders for ceramic green sheets with improved properties regarding residual particles as well as processes for the production of such polyvinyl acetals. A further objective was to provide such binders leading to improved rate of dissolution, adhesion, improved handling, improved elongation-at-break, improved tensile strength, improved dispersion effect, an improved environmental, health and safety impact and/or with a better economical profile in the production and use of the ceramic green sheet.

The current inventors have now surprisingly found that one major source of particles in the range of 2 to 5 μm are trace amounts of sodium chloride contained in the final polyvinyl acetal powders. Since sodium chloride does not dissolve in the organic solvents used to prepare the binder solution and the suspension used in the production of the green sheets, it remains as residual particles. Polyvinyl acetals are generally produced by an acetalization process in which polyvinyl alcohol and an aldehyde are converted to the corresponding acetal in the presence of an acid. Hydrochloric acid is frequently used in this respect. After precipitation of the polyvinyl acetal, the crude product is washed with water to remove the acid to neutrality and the washed product is subsequently dried.

Normal water as used in industrial parks can contain quite a substantial amount of chloride ions. For example, the upper limit of chloride content in the tap water in the Industrial Park Hoechst in Germany was 250 mg/l in 2020. As a result, even thorough washing of the polyvinyl acetal with water to remove the remaining hydrochloric acid will lead to a final product with a rather high content of chloride since the washing water itself contains chloride ions. This chloride content then leads to a higher content of residual particles, especially in the critical low-nanometer range.

Accordingly, a first aspect of the present invention concerns a process for the production of a polyvinyl acetal powder comprising the steps of
a. reacting a polyvinyl alcohol with an aldehyde in the presence of an acid to prepare the polyvinyl acetal,
b. precipitating the polyvinyl acetal obtained in step a,
c. washing the precipitate obtained in step b with a washing liquid comprising water, and
d. drying the washed precipitate of step c,
wherein the washing liquid in step c contains equal to or less than 100 mg/l chloride ions.

The chloride content in the washing liquid is measure according to ASTM D512-04 by silver nitrate titration (Test Method B).

Preferably, the washing liquid in step c contains equal to or less than 80 mg/l, more preferably less than 75, even more preferably less than 50 and most preferably less than 30 and specifically less than 20 mg/l chloride ions. Also preferably, the washing liquid contains between 0.1 and 10 mg/l chloride ions.

The washing liquid can be a mixture of water and a water-miscible solvent, e.g. an alcohol like methanol, ethanol or isopropanol. Preferably, the washing liquid essentially consists of water.

The acids which can be used are those which are known for the manufacturing processes of polyvinyl acetals, for example, hydrochloric acid, sulfuric acid, nitric acid or mixtures of these acids. Preferably, the acid is hydrochloric acid.

The chloride content of the washing liquid can be reduced by any method known in the art. Mechanisms for chloride removal mainly include chemical precipitation, adsorption, oxidation and membrane separation. In chemical precipitation, chloride is removed by forming CuCl, AgCl, BiOCl and Friedel's salt. Adsorbents used in chloride removal mainly include ion exchangers, bimetal oxides and carbon-based electrodes. Oxidation for chloride removal contains ozone-based, electrochemical and sulfate radical-based oxidation. Membrane separation for chloride removal consists of diffusion dialysis, nanofiltration, reverse osmosis and electrodialysis. Preferably, the amount of chloride in the washing liquid is reduced by chemical precipitation, reverse osmosis, adsorption and/or oxidation.

Using a washing liquid and specifically water with a low chloride content leads to a final polyvinyl acetal powder with a low chloride content. Accordingly, in one embodiment of the present invention the polyvinyl acetal powder contains equal to or less than 25 ppm chloride, more preferably less than 20 ppm, even more preferably less than 15 ppm and most preferably less than 10 ppm and specifically less than 5 ppm chloride.

Preferably, the polyvinyl acetal has a molecular weight of equal to or more than 20,000 g/mol when measured by gel permeation chromatography according to DIN ISO 16014 1:2019-05.

The molecular weight is determined by gel permeation chromatography according to DIN ISO 16014 1:2019-05. Preferably, the molecular weight is equal to or more than 40,000 g/mol, more preferably 50,000 g/mol. Also preferably, the molecular weight is equal to or less than 200,000 g/mol, more preferably equal to or less than 175,000 g/mol, most preferably equal to or less than 150,000 g/mol and specifically equal to or less than 100,000 g/mol.

Preferably, the acetal groups of the polyvinyl acetal individually have 1 to 7 carbon atoms, i.e. they derive from the condensation reaction with aldehydes with 1 to 7 carbon atoms. More preferably, they derive from the list consisting of methanal (formaldehyde), acetaldehyde, n-propanal (propionaldehyde), n-butanal (butyraldehyde), iso-butanal (2-methyl-1-propanal, iso-butyraldehyde), n-pentanal (valeraldehyde), iso-pentanal (3-methyl-1-butanal), sec-pentanal (2-methyl-1-butanal), tert-pentanal (2,2,dimethyl-1-propanal), n-hexanal (capronaldehyde), iso-hexanal (2-methyl-1-pentanal, 3-methyl-1-pentanal, 4-methyl-1-pentanal), 2,2-dimethyl-1-butanal, 2,3-dimethyl-1-butanal, 3,3-dimethyl-1-butanal, 2-ethyl-1-butanal, n-heptanal, 2-methyl-1-hexanal, 3-methyl-1-hexanal, 4-methyl-1-hexanal, 5-methyl-1-hexanal, 2,2-dimethyl-1-pentanal, 3,3-dimethyl-1-pentanal, 4,4-dimethyl-1-pentanal, 2,3-dimethyl-1-pentanal, 2,4-dimethyl-1-pentanal, 3,4-dimethyl-1-pentanal, 2-ethyl-1-pentanal, 2-ethyl-2-methyl-1-butanal, 2-ethyl-3-methyl-1-butanal, 3-ethyl-2-methyl-1-butanal, cyclohexylaldehyde and benzaldehyde. More preferably, they derive from the condensation reaction with iso-butyraldehyde, acetaldehyde and/or n-butyraldehyde. Most preferably, the polyvinyl acetal is polyvinyl butyral or a mixed polyvinyl acetal derived from a condensation with n-butyraldehyde and acetaldehyde.

Although there is no particular limitation to the method for producing the polyvinyl acetals used in this embodiment of the present invention, they can be produced by a method in which an aldehyde is added to a polyvinyl alcohol solution under acidic conditions and thus, subjected to an acetalization reaction.

Preferably, the degree of acetalization of the polyvinyl acetals used in the present invention is 50 mol % or more and less than 90 mol %, more preferably the lower limit of the degree of acetalization is more than 60 mol %, even more preferably more than 70 mol % and most preferably more than 80 mol %. Further, the upper limit of the degree of acetalization is more preferably 90 mol % or less, and most preferably 85 mol % or less.

Preferably, the percentage of vinyl alcohol units in the polyvinyl acetals of the present invention is 10 to 25 mol %, more preferably 15 to 20 mol % based on the total monomer unit constituting the resin.

The vinyl alcohol content and vinyl acetate content of polyvinyl acetal were determined in accordance with DIN ISO 3681 (Acetate content) and DIN ISO 53240 (PVA content).

In a second aspect, the present invention concerns a suspension composition comprising one or more inorganic pigments, one or more organic solvents, one or more binders, one or more plasticizers, and one or more dispersing agents, wherein the binder is the polyvinyl acetal as described above.

Preferably, the acetal group has 2 to 7 carbon atoms and is derived from the same aldehyde(s) as described above. Most preferably, the acetal group is derived from n-butyraldehyde or from a mixture of n-butyraldehyde and acetaldehyde.

The inorganic pigments can be chosen from finely ground granules of paraelectric or ferroelectric raw materials and include titanium dioxide (rutile), preferably modified by additives of zinc, zirconium, niobium, magnesium, tantalum, cobalt and/or strontium, as well as compounds chosen from MgNb₂O₆, ZnNb₂O₆, MgTa₂O₆, ZnTa₂O₆, (ZnMg)TiO₃, (ZrSn)TiO₄, BaTiO₃, and Ba₂Ti₉O₂₀. The average particle diameter of the inorganic pigments is preferably about 0.01 to 1 μm.

The organic solvent may be chosen from aromatic compounds, such as toluene and xylene, and alcohol compounds, such as methanol, ethyl alcohol, isopropyl alcohol and butyl alcohol and more preferably, mixtures thereof. Most preferably, the organic solvent is a mixture of ethanol and toluene.

Suitable dispersing agents include fish oil, phosphoric acid esters and functional polymers comprising polyoxyalkylene groups on side chain, such as the MALIALIM™ series commercially available from NOF America Cooperation.

In addition to the binder according to the present invention, the suspension may comprise other components chosen inter alia from other binders like cellulose resins, acrylic resins, vinyl acetate resins, polyvinyl alcohol resins; plasticizers such as polyethylene glycol or phthalic esters, and/or a defoamer.

The method to produce the suspension composition is not specifically limited. Various dispersing methods may be used, for example, a method of using a media-type mill, such as a bead mill, a ball mill, an attritor, a paint shaker and a sand mill; a method of kneading a powdered ceramic, a dispersing medium, a dispersing agent, a binder, a plasticizer and the like; and a method of using a three-roll mill. Using a three-roll mill, the method includes dispersing a powdered inorganic pigment in an organic solvent (mixture) together with a dispersing agent, a binder, a plasticizer, and the like. The mixture is passed through a small gap between a first roller and a second roller, which roll independently from each other and are adjacent to each other with the small gap therebetween, so as to be compressed and kneaded, and subsequently, the mixture is passed between the second roller and a third roller, which rolls and is adjacent to the second roller with a smaller gap therebetween than the gap between the first and the second rollers, so as to be further compressed and kneaded.

Preferably, the powdered ceramic, dispersing agent, and solvent (mixture) are pre-mixed and dispersed so that the dispersing agent is adsorbed on the powdered ceramic. In a second step, the binder is added to the mixture thus formed, and subsequently, mixing and dispersing is performed again.

The dry film thickness of the coating film produced by these processes can be 0.25 to 25 μm, and typically, 1 to 15 μm.

A third aspect of the present invention concerns the use of the polyvinyl acetal powder obtained in the inventive process as a binder for the production of a ceramic green sheet or a ceramic moulded body.

A fourth aspect of the present invention concerns a polyvinyl acetal with a residual particle count of particles with a particle size from 2 to 500 μm of equal to or less than 500 counts/ml and with a ratio of the residual particle count of particles with a particle size from 2 to 5 μm divided by the residual particle count of particles with a particle size from 2 to 20 μm of equal to or less than 0.8 wherein the residual particle count is measured as described in the description in a 2% by weight solution in a 1:1 mixture of toluene and ethanol. Preferably, the ratio is equal to or less than 0.75, more preferably equal to or less than 0.70, even more preferably equal to or less than 0.65 and most preferably equal to or less than 0.60 and specifically equal to or less than 0.50.

Also preferably, the residual particle count of particles with a particle size from 2 to 500 μm is equal to or less than 450 counts/ml, more preferably equal to or less than 400 counts/ml, even more preferably equal to or less than 350 counts/ml and most preferably equal to or less than 300 counts/ml.

Such polyvinyl acetals with an overall low amount of residual particles and specifically with a low ratio of residual particles in the critical range of 2 to 5 μm are particularly useful for the production of ceramic green sheets.

### EXAMPLES

### Synthesis of the Polyvinyl Acetals

### Polyvinyl Butyral (PVB 1)

100 parts by weight of a polyvinyl alcohol with a viscosity of 19 mPas (8 w/w % in aqueous solution measured according to DIN 53015 at 20° C.) and a degree of hydrolysis of 98 mol % was dissolved in 1000 parts by weight of water with heating to 90° C. At a temperature of 40° C., 65 parts by weight of n-butyraldehyde was added, and at a temperature of 5° C., while stirring, 250 parts by weight of 20% hydrochloric acid was added. The mixture was heated to 40° C. After the polyvinyl butyral (PVB) had precipitated, the mixture was stirred at this temperature for 48 h. The PVB was separated after cooling to room temperature, washed to neutrality with water having a chloride content of 9.4 mg, and dried. A PVB having a polyvinyl alcohol content of 12.7% by weight (19.1 mol %) and a polyvinyl acetate content of 2.3% by weight (1.8 mol %) was obtained.

### Mixed Polyvinyl Acetal (PVB 2)

100 parts by weight of a polyvinyl alcohol with a viscosity of 50 mPas (8 w/w % in aqueous solution measured according to DIN 53015 at 20° C.) and a degree of hydrolysis of 99 mol % was dissolved in 1000 parts by weight of water with heating to 90° C. At a temperature of 40° C., 200 parts by weight of 20% hydrochloric acid was added, and at a temperature of 12° C., while stirring, first 22 parts by weight of acetaldehyde and then 30 parts by weight of n-butyraldehyde were added. The mixture was heated to 40° C. After the polyvinyl butyral (PVB) had precipitated, the mixture was stirred at this temperature for 48 h. The PVB was separated after cooling to room temperature, washed to neutrality with water having a chloride content of 9.4 mg, and dried. A PVB having a polyvinyl alcohol content of 12.5% by weight (18.8 mol %) and a polyvinyl acetate content of 1.7% by weight (1.3 mol %) was obtained.

### Polyvinyl Butyral (PVB 3)

100 parts by weight of polyvinyl alcohol with a viscosity of 26 mPas (4 w/w % in aqueous solution measured according to DIN 53015 at 20° C.) and a degree of hydrolysis of 99 mol % was dissolved in 1075 parts by weight of water with heating to 90° C. At a temperature of 40° C., 57 parts by weight of n-butyraldehyde was added, and at a temperature of 10° C. while stirring, 75 parts by weight of 20% hydrochloric acid was added. The mixture was heated to 70° C. after the polyvinyl butyral (PVB) had precipitated and stirred at this temperature for 1 hour. The PVB was separated after cooling to room temperature, washed to neutrality with water having a chloride content of 9.4 mg/l, and dried. A PVB having a polyvinyl alcohol content of 20.0% by weight (28.8 mol %) and a polyvinyl acetate content of 1.4% by weight (1 mol %) was obtained.

### Measurement of the Particle Size Distribution

2 g of PVB 3 powder was dissolved in 98 g of a solvent mixture (1:1 mixture of ethanol and toluene) using a tilting/rotating mixer. After 24 hours, a 50 ml sample was taken and analyzed by single particle measurement with laser focus using the Accusizer™ 780 by Soliton GmbH. Only particles with sizes in the range of 2-500 μm were counted.

| | Counts | Counts | Counts | |
|---|---|---|---|---|
| | per ml | per ml | per ml | Ratio |
| Substrate | (2-500 μm) | (2-5 μm) | (2-20 μm) | 2-5 μm/2-20 μm |
| PVB 3 | 393 | 272 | 381 | 0.71 |

1. A process for the production of a polyvinyl acetal powder comprising the steps of
a. reacting a polyvinyl alcohol with an aldehyde in the presence of an acid to prepare the polyvinyl acetal,
b. precipitating the polyvinyl acetal obtained in step a,
c. washing the precipitate obtained in step b with a washing liquid comprising water, and
d. drying the washed precipitate of step c,
wherein the washing liquid in step c contains equal to or less than 100 mg/l chloride ions.

2. The process according to claim 1 wherein the washing liquid in step c contains equal to or less than 30 mg/l chloride ions.

3. The process according to claim 1 wherein the washing liquid in step c contains equal to or less than 10 mg/l chloride ions.

4. The process according to claim 1 wherein the washing liquid consists essentially of water.

5. The process according to claim 1 wherein:
the aldehyde is n-butanal or a mixture of n-butanal and acetaldehyde; and
the polyvinyl acetal is polyvinyl butyral or a mixed polyvinyl acetal derived from a condensation with n-butanal and acetaldehyde.

6. The process according to claim 1 wherein the acid is hydrochloric acid.

7. The process according to claim 1 wherein the amount of chloride in the washing liquid is reduced by chemical precipitation, reverse osmosis, adsorption and/or oxidation.

8. The process according to claim 1 wherein the polyvinyl acetal powder contains equal to or less than 25 ppm chloride.

9. The process according to claim 1 wherein the polyvinyl acetal powder contains equal to or less than 10 ppm chloride.

10. A binder for the production of a ceramic green sheet or a ceramic moulded body, wherein the binder comprises polyvinyl acetal powder produced by the process of claim 1.

11. A polyvinyl acetal with a residual particle count of particles with a particle size from 2 to 500 mm of equal to or less than 500 counts/ml and with a ratio of the residual particle count of particles with a particle size from 2 to 5 mm divided by the residual particle count of particles with a particle size from 2 to 20 mm of equal to or less than 0.8 wherein the residual particle count is measured as described in the description in a 2% by weight solution in a 1:1 mixture of toluene and ethanol.

12. The polyvinyl acetal according to claim 11 wherein the ratio is equal to or less than 0.75.

13. A ceramic green sheet or a ceramic moulded body comprising the polyvinyl acetal of claim 11.
